(19) United States
(12) Patent Application Publication
(10) Pub. No.: US 2019/0170537 A1
(43) Pub. Date: Jun. 6, 2019

(54) Method and System for Providing a Self-Rescue Plan in an Emergency

(71) Applicants: Sterland Gibson, Lawrenceburg, TN (US); Barbara A. Gibson, Lawrenceburg, TN (US); Ahmed Ibrahim, Lawrenceburg, TN (US)

(72) Inventors: Sterland Gibson, Lawrenceburg, TN (US); Barbara A. Gibson, Lawrenceburg, TN (US); Ahmed Ibrahim, Lawrenceburg, TN (US)

(21) Appl. No.: 16/212,651

(22) Filed: Dec. 6, 2018

Related U.S. Application Data
(60) Provisional application No. 62/595,386, filed on Dec. 6, 2017.

(51) Int. Cl. G01C 21/36; G01C 21/34

(52) U.S. Cl. CPC G01C 21/3682; G01C 21/3484; G01C 21/3697

(57) ABSTRACT

A method and system for providing self-rescue plan in emergency comprises an overall process of presenting detailed information associated with a desired fuel station to a plurality of driver users. Upon receiving a fuel station selection, the method provides the driver user with a route to the fuel station and corresponding status information such as total amount of fuel available, fuel types and grades, prices, pumps, etc. The method also offers service facilities along the route to the driver user to handle life-threatening emergencies. Additionally, the method provides a process for each station user account to enter and update the fuel station related statuses, supplemental supplies and services so that accurate information is presented to the specific driver user in emergency. Further, the method assists an arbitrary user to locate and reach a desired friend in order to help and/or rescue the friend in emergency.

The current application claims a priority to the U.S. Provisional Patent application Ser. No. 62/595,386 filed on Dec. 6, 2018.

### FIELD OF THE INVENTION

The present invention generally relates to the field of emergency services. More specifically, the present invention relates to a method and system for providing a self-rescue plan in an emergency.

### BACKGROUND OF THE INVENTION

Unexpected calamities and/or disasters, such as, hurricanes, tornadoes, flood, earthquakes, tsunami, volcanic eruptions, etc., occur frequently across the world. When an unexpected disaster occurs, people often find themselves in challenging situations while travelling on highways or trying to evacuate. Therefore, they may not have access to necessary facilities, such as, gas stations, and food outlets. Further, people may be confused during emergency situations on how to protect themselves and their loved ones. For example, there may be a challenging scenario where there is a need to evacuate thousands of people stuck in their homes because of a hurricane attack. Accordingly, in such challenging scenarios, people may be anxious about their ability to reach a safer place with the limited amount of fuel and/or gas available in their vehicle's fuel tank.

In 2005, thousands of Texans along the Gulf Coast ran out of gas while trying to escape Hurricane Rita. The stationary vehicles of these individuals only worsened the gridlock along evacuation routes, and led to long lines at gas stations, many of which also ran short of fuel. Hurricane Rita exposed substantial problems when it came to fuel for vehicles: lots of corner stores and other fueling stations did not keep their underground storage tanks full at a critical time, and many of the 3.6 million Southeast Texans fleeing the coast did not fill up before hitting the highways. Fuel demands rapidly overwhelmed local supplies. And with roads shut down or clogged, fuel tankers struggled to bring in reinforcements. In 2017, when Hurricane Harvey left its path of devastation across Texas and the neighboring states, one of the lesser known side effects was that a lot of the cars were left behind. An estimated one million cars were completely destroyed in the 2017 disaster—more than in any other weather event in American history. While Harvey was indeed a “100-year storm”, it highlighted the power and dangers of storm-related flooding that can happen anywhere.

For a driver, knowing what to do when a disaster is looming is critical. The vehicle can be an invaluable tool to get a user to safety before the disaster strikes. The user needs to understand what to do to stay safe as the user either evacuates the disaster zone or prepares to ride out the emergency. After a serious natural disaster, the roadways in the affected area may be completely destroyed, traffic signs downed, and emergency personnel stretched thin. There is a significant risk, even after the worst of the event has passed, that the user may not be able to find fuel.

During 2017 Hurricane Irma, in Gainesville, Fla., some 45 percent of gas stations were running dry, while in West Palm Beach, it was 50 percent. These were the tough realities Floridians who evacuated in the face of Hurricane Irma. An unprecedented six million fled from the Category 5 storm, the largest evacuation in U.S. history. The exodus created widespread gas shortages in the days before landfall, with the majority of South Florida gas station during the week when Irma hit the region. Disabled and abandoned vehicles dotted northbound routes. It was a situation that paralyzed many Floridians who wanted to evacuate but felt trapped or even terrified of attempting to drive away. In transit-deficient South Florida, personal vehicles remain the default mode of evacuation for most of the population. If there is not enough gas for them—and if other climate-related disasters are affecting supply, it is crucial for the user to get fuel for evacuation purpose.

But right now, no alternative is much better. Most existing electric vehicles (EVs) with advanced technologies to extend the range of certain cars made a lot of headlines, but they also spot-lit the current limits of EVs as escape pods: without more robust charging infrastructure, EVs are risky bets for an evacuees. And with power outages still widespread, no charge could be just as fatal as no gas. High-speed rail is coming to South Florida, slowly, but not with the regional connections that would make it a viable escape route ahead a hurricane. Shared mobility services, like Uber and Lyft, are likewise only good for short-distance travel, may not be sufficient for evacuation.

Another example is earthquake. According to a 2013 seismic risk study released by the state of Oregon, much of Oregon's population would face extended fuel shortages, natural gas outages and blackouts after a catastrophic earthquake. The Oregon risk assessment looked specifically at the concentration of fuel tank farms, pipelines, marine terminals, and transmission towers along the lower Willamette River on the northwest side of Portland. The study predicted violent shaking, liquefaction and landslides from a magnitude 8 or 9 earthquake would cause pipe breaks, rupture fuel storage tanks, topple transmission towers and destroy berths.

A lot of times during a catastrophic situation, coping mechanisms in place, for example first responders, 911, etc., are found to be insufficient. It is not because responders do not want to help. As many disaster preparation experts agree, it is because, they are not ready to jump with a region-wide response when something that big happens. It is a sobering thought, and that is why a user needs to be ready to be on their own. Experts agree emergency resources by the government are tailored for common occurrences like a flood or a landslide and are not nearly ready for a disaster for the history books because of limited resources. It does not take much to overwhelm the existing resources. First responders are not able to respond to all of individuals in need. They will likely first go to places where there is the highest concentration of people, so they can do the most good at once. Those normally are schools or nursing homes. If the user's house is on fire, firefighters may pass by the user to get to another, larger disaster scene. Therefore, there is a need for taking extraordinary measures in order to provide relief in such situations.

Further, there are existing systems and/or applications that display the gas stations that are available near to a user's location. However, a user may reach a gas station recommended by such applications, only to find out that there is no gas available at the recommended gas station.

Therefore, there is a need for improved methods and systems for providing a self-rescue plan in an emergency situation that may overcome the abovementioned problems and/or limitations. The present invention, a method for self-rescue plan offers the user an easy-to-use and efficient tool to search and find suitable fuel available for the user's vehicle while trying to evacuate. Not only the present invention provides detailed route for the user to drive to the desired fuel station, but also the method of the present invention presents the detailed information such as total amount of fuel and total pumps available, estimated number of vehicles coming to the same station for fuel, available supplies and vehicle services, shelters, food, etc., for the desired fuel station. Additionally, the present invention provides available facilities on the route to the desired fuel station, including food, shelter, hospital, vehicle garage, etc. Further, the present invention can provide similar information for the user driving an EV, or in an emergency situation trying to locate and find one or more family member, loved one, and/or friend.

### SUMMARY

A method and system of an online platform provides a user a self-rescue plan in an emergency. The online platform presents a software app on the user's computing device operated by the user. The app includes input fields, such as, estimated and/or maximum number of miles that vehicle can cover without emptying vehicle's fuel tank, desired fuel station, type of fuel, and/or estimated mileage associated with the vehicle. Further, the method presents a map-based display that includes a search radius that is highlighted to mark a region within which the driver locates the fuel stations and/or charging stations. The method displays the fuel stations as well as the charging stations along with availability information for fuel-based vehicles and electric vehicles respectively. The availability information for the fuel stations represents total number of lanes and fuel pumps available at the fuel station, availability of convenience stores, and/or vehicle repair/maintenance services. Accordingly, the method displays a route to arrive at the charging stations in an emergency situation. Additionally, the method includes a feature of assisting a driver (e.g. victim who is running away from a village affected by a hurricane attack) during an emergency and/or during a disaster by displaying an escape route associated with locality and/or area associated with the user device. Furthermore, the escape route also includes various fuel stations, food outlets, and accommodation services. The driver user may be under a state of stress because of the limited fuel and/or the gas available in vehicle's fuel tank. Then, the driver cab use the method of the present invention to enter an estimated number of miles that may be covered with the limited amount of fuel in the vehicle's fuel tank. The estimated number of miles may be based upon judgment of the driver user. Once a fuel station is selected, the method presents information associated with the fuel station, such as, types of fuel available, quantity of fuel, available food outlets, and other supplies and services. Additionally, the method also presents the escape route associated with the fuel stations displayed in a map. The method may assist the specific driver user to find and physically reach a friend user that is in an emergency with a map showing the location of and a route leading to the friend. Thus, the present invention is an efficient and convenient tool providing any user with a self-rescue plan.

### BRIEF DESCRIPTION OF THE DRAWINGS

FIG. 1 is a block diagram illustrating the system overview of the present invention.

FIG. 2 is a flowchart illustrating the overall process followed by the method of the present invention.

FIG. 3 is flowchart illustrating a sub-process for a specific user account to search for electric charging stations for the user's electric vehicle.

FIG. 4 is flowchart illustrating a sub-process to manage a set of supplies and services for each fuel station.

FIG. 5 is flowchart illustrating a sub-process to identify and present to the specific user account a list of secondary service facilities along the route to the desired fuel station.

FIG. 6 is flowchart illustrating a sub-process to present to the specific user account a map with the list of secondary service facilities along the route to the desired fuel station.

FIG. 7 is flowchart illustrating a sub-process identify the total in-transit user accounts with the same fuel station selection as the specific user account.

FIG. 8 is flowchart illustrating a sub-process that manages the detailed fuel and fuel pump statuses associated with each fuel station selection by the specific user account.

FIG. 9 is flowchart illustrating a sub-process that manages the detailed charging lane statuses associated with each charging station selected by the specific user account.

FIG. 10 is flowchart illustrating a sub-process to provide a map to present the location of the specific user account.

FIG. 11 is flowchart illustrating a sub-process to provide a map to present the route to the desired fuel station to the specific user account.

FIG. 12 is flowchart illustrating a sub-process to provide a map to present the search results to the specific user account.

FIG. 13 is flowchart illustrating a sub-process for locating and tracking a friend for an arbitrary user account.

FIG. 14 is flowchart illustrating a sub-process to provide a map for locating and tracking a friend for an arbitrary user account.

FIG. 15 is flowchart illustrating a sub-process that provides a route for the arbitrary user to physically reach the friend.

FIG. 16 is flowchart illustrating a sub-process that provides a map with the route for the arbitrary user to physically reach the friend.

FIG. 17 is flowchart illustrating a sub-process to manage the characteristics of each fuel station.

### DETAIL DESCRIPTIONS OF THE INVENTION

All illustrations of the drawings are for the purpose of describing selected versions of the present invention and are not intended to limit the scope of the present invention.

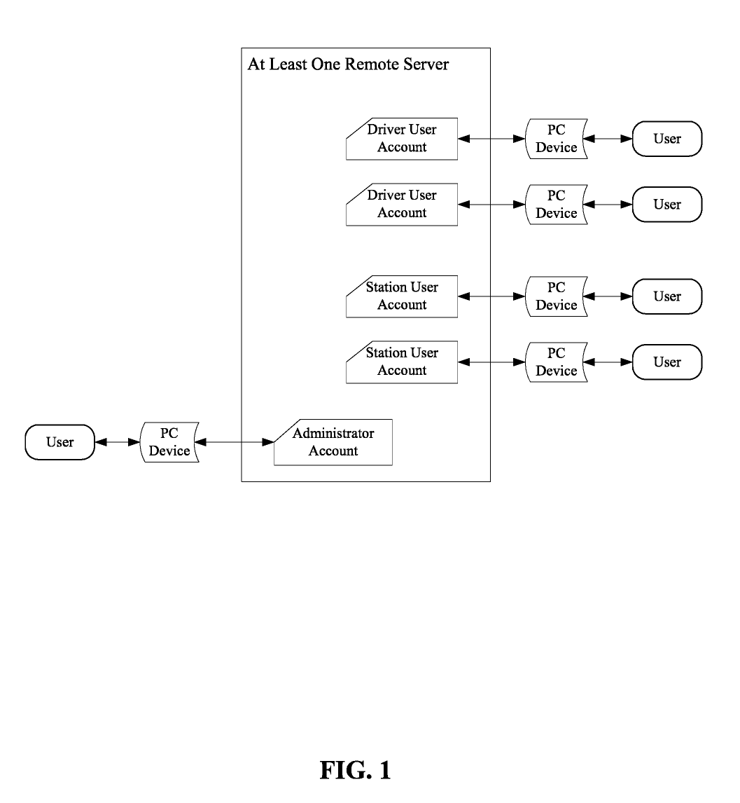

As can be seen in FIG. 1 through FIG. 17, the preferred embodiment of the present invention is a system and method for providing a self-rescue plan in an emergency for a plurality of user accounts. The method of the present invention provides a specific user associated with a user account an easy-to-use and efficient tool to search and find suitable fuel available for the user's vehicle while trying to evacuate with limited amount of fuel or a close-to-empty fuel tank in the vehicle. Specifically, the method of the present invention offers a detailed route for the user to drive to a desired fuel station and presents the detailed information such as total amount of fuel and total pumps available at the desired fuel station. Additionally, the method allows a station user associated with the fuel station selected to enter specific information such as available electric vehicle (EV) charging stations, available services such as food, supplies, wash rooms, vehicle repair, etc., so that such information can be relayed to the specific user who selected the fuel station. Once the route to the desired fuel station is relayed to the specific user, the method offers search results for secondary service facilities along the route to the desired fuel station such as hospitals, hotels, food, shelters, vehicle garages, etc., so that the specific user can handle any emergence need while driving to the fuel station. Further, the method allows the specific user to locate one or more friend associated with the plurality of user accounts and relays the specific user a route to drive to the friend. Any of the locations, routes, fuel stations, secondary service facilities can be presented in a graphical format including, but not limited to, a map.

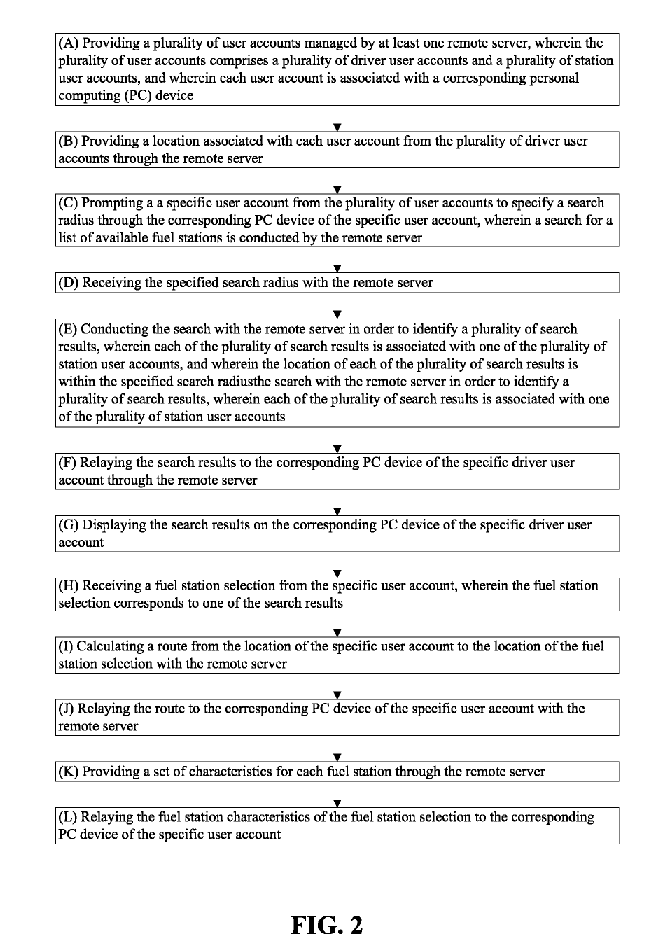

As can be seen in FIG. 1, the method of present invention provides a self-rescue plan platform in an emergency. To accomplish this, the method of the present invention provides a plurality of user accounts managed by at least one remote server, wherein the plurality of user accounts comprises a plurality of driver user accounts and a plurality of station user accounts, and wherein each user account is associated with a corresponding personal computing (PC) device (Step A), as seen in FIG. 2. Each driver user associated with a driver user account interacts with the system of the present invention through the at least one remote server to utilize the self-rescue plan in an emergency, while each station user associated with a station user account provides and updates the detailed information for the associated fuel station, which is relayed to the plurality of driver user accounts through the remote server. Further, each of the plurality of user accounts is associated with a corresponding user personal computing (PC) device. The corresponding user PC device allows a user to interact with the system of present invention and can be, but is not limited to, a smartphone, a smart watch, a laptop, a desktop, or a tablet PC. The users of the user accounts may include relevant parties such as, but are not limited to, individuals, consumers, corporations, fuel station owners, advertisers and administrators. Further, the at least one remote server is used to provide the self-rescue plan for the plurality of user accounts. The remote server can be managed through an administrator account by an administrator as seen in FIG. 1. Moreover, the remote server is used to execute a number of internal software processes and store data for the present invention. The software processes may include, but are not limited to, server software programs, web-based software applications or browsers embodied as, for example, but not be limited to, websites, web applications, desktop applications, and mobile applications compatible with a corresponding user PC device. Additionally, the software processes may store data into internal databases and communicate with external databases, which may include but are not limited to map databases (such as Google Maps®), fuel station databases, EV charging station databases, databases maintaining data about service facilities such as, but not limited to, hospitals, hotels, vehicle garages, shelters, weather stations, etc. The interaction with external databases over a communication network may include, but is not limited to, the Internet.

As can be seen in FIG. 2, the overall process of the method used to execute the self-rescue plan of the present invention provides a location associated with each user account from the plurality of driver user accounts through the remote server (Step B). The location is the current physical location of a driver user. For a specific user who is using the present invention, the method prompts the specific user account from the plurality of user accounts to specify a search radius through the corresponding PC device, wherein a search for a list of available fuel stations is conducted by the remote server (Step C). Specifically, the specific user can provide the search radius to the system based on, but not limited to, an estimate of distance the user's vehicle can travel at a certain speed. Once the specified search radius is received by the remote server (Step D), the method conducts the search with the remote server in order to identify a plurality of search results, wherein each of the plurality of search results is associated with one of the plurality of station user accounts (Step E). Next, the method relays the search results to the corresponding PC device of the specific driver user account through the remote server (Step F) and displays the search results on the corresponding PC device of the specific driver user account (Step G). Based on the situation, the user makes a selection from the listed search results—fuel stations. The method then receives the fuel station selection from the specific user account, wherein the fuel station selection corresponds to one of the search results (Step H), calculates a route from the location of the specific user account to the location of the fuel station selection with the remote server (Step I), and relays the route to the corresponding PC device of the specific user account with the remote server (Step J). Further, the overall process of the present invention provides detailed information with each fuel station associated with the plurality of station user accounts and relays the specific information of the fuel station selection to the specific user account. Specifically, the method provides a set of characteristics for each fuel station through the remote server (Step K) and subsequently relays the fuel station characteristics of the fuel station selection to the corresponding PC device of the specific user account (Step L). The characteristics of each fuel station include, but are not limited to, fuel types, fuel grades, number of fuel pumps for each fuel type, fuel lanes, price of each fuel type and grade, EV charging stations, parking, food, supplies, washing rooms, shelters, services, vehicle repair and maintenance services, etc.

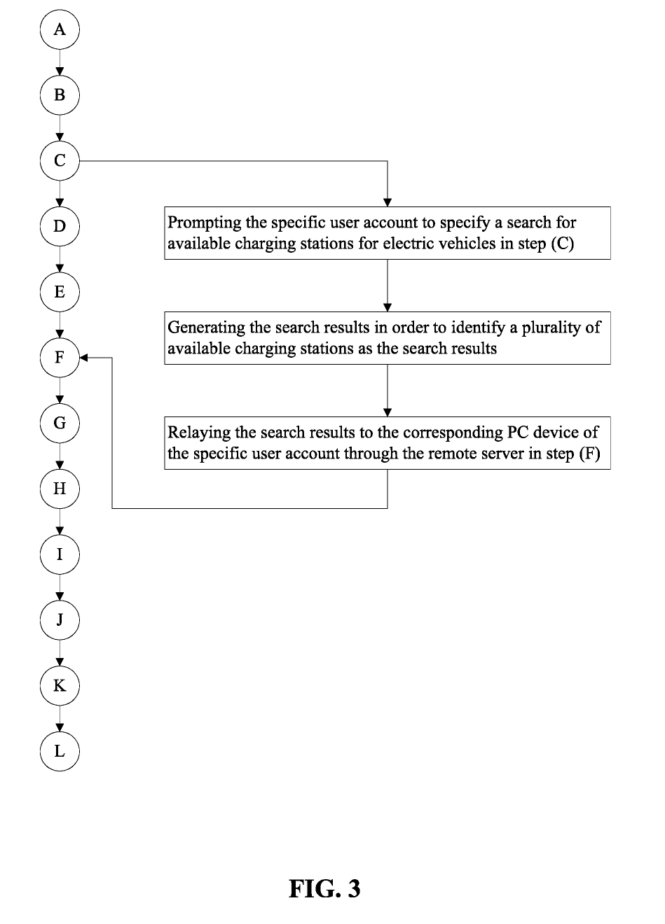

As can be seen in FIG. 3, the method of the present invention provides a sub-process for the specific user account to search for electric charging stations for the user's EV. More specifically, the method prompts the specific user account to specify a search for available charging stations for electric vehicles in Step C, generates the search results in order to identify a plurality of available charging stations as the search results, and then relaying the search results to the corresponding PC device of the specific user account through the remote server in Step F. An EV charging station may or may not belong to a fuel charging station.

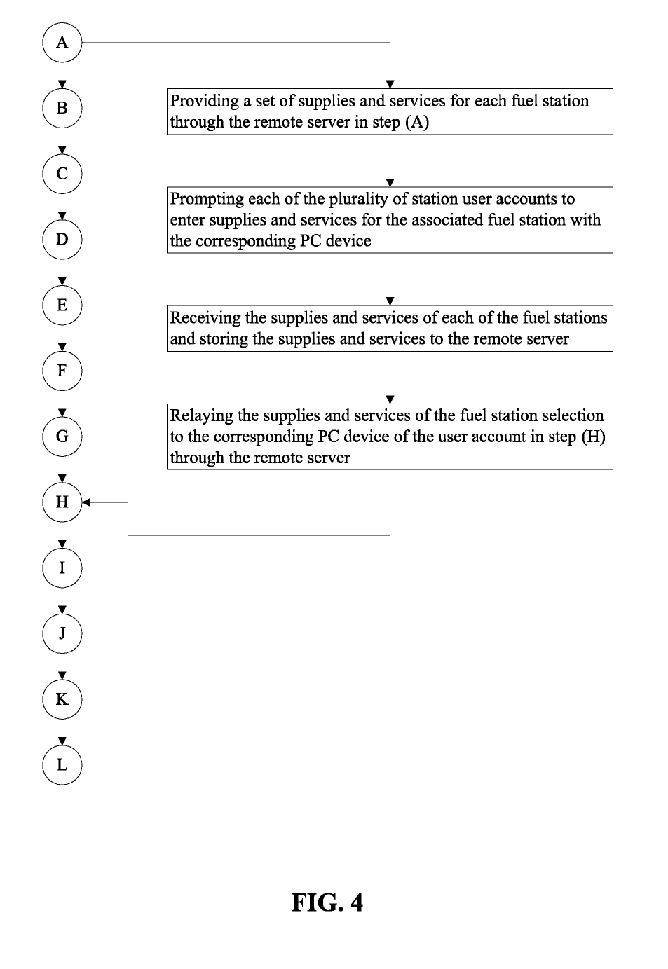

As can be seen in FIG. 4, the method offers a sub-process to manage a set of supplies and services for each fuel station. More specifically, the method of the present invention provides providing a set of supplies and services for each fuel station through the remote server in Step A and prompts each of the plurality of station user accounts to enter supplies and services for the associated fuel station with the corresponding PC device. Subsequently, the method receiving the supplies and services of each of the fuel stations and storing the supplies and services to the remote server and relaying the supplies and services of the fuel station selection to the corresponding PC device of the user account in Step H through the remote server. In this process, the method allows each station user associated with the plurality of station user account to enter specific information regarding the fuel station, wherein the information includes, but is not limited to, supplies and services such as food, convenient store supplies, vehicle related supplies (parts, engine oils, etc.), wash rooms, shelters, vehicle repair and maintenance services, etc.

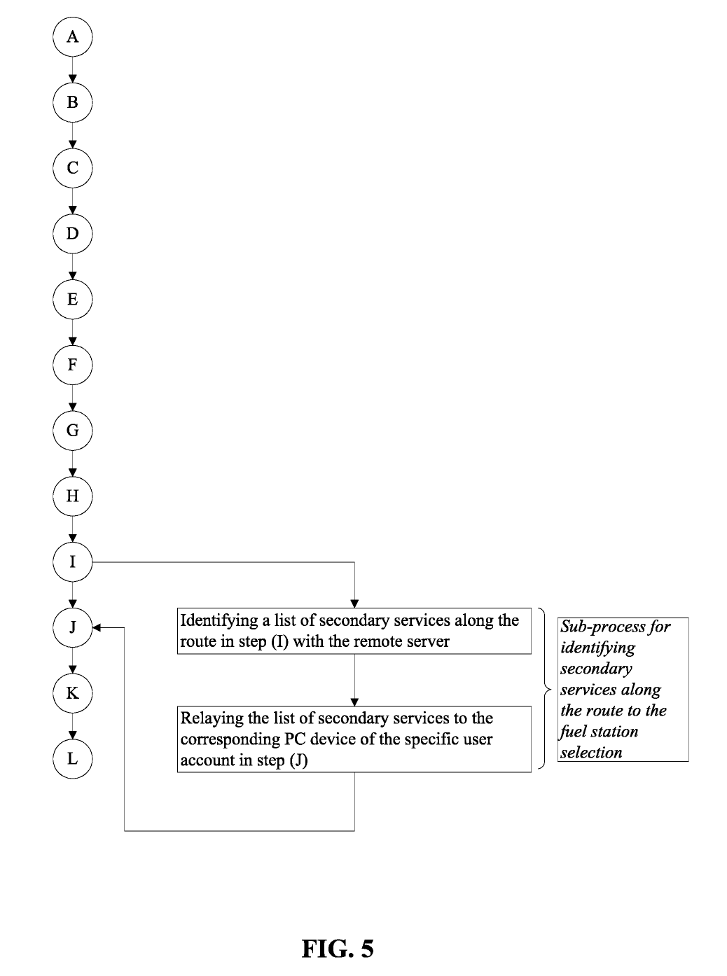

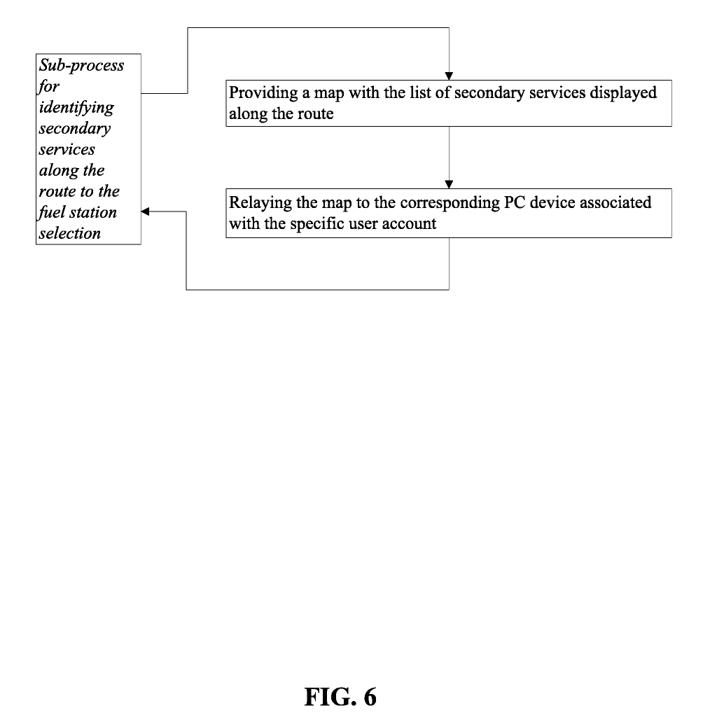

As can be seen in FIG. 5, the method further provides a sub-process to identify and present to the specific user account a list of secondary service facilities along the route. Specifically, the method identifies a list of secondary services along the route in step I with the remote server and then relays the list of secondary services to the corresponding PC device of the specific user account in Step J. This process allows the specific user to make decision for dropping by any desired service facility on the route to the chosen fuel station. For example, the specific use may choose to drive to a hospital first due to a serious injury of some family member. The secondary services include, but are not limited to, hospitals, shelters, food, wash rooms, vehicle garages, etc. In an alternative embodiment of the present invention, the method may provide a map with the list of secondary services displayed along the route and relays the map to the corresponding PC device associated with the specific user account, as seen in FIG. 6. In other embodiments, the method may provide other forms of graphical presentation of the list of secondary services.

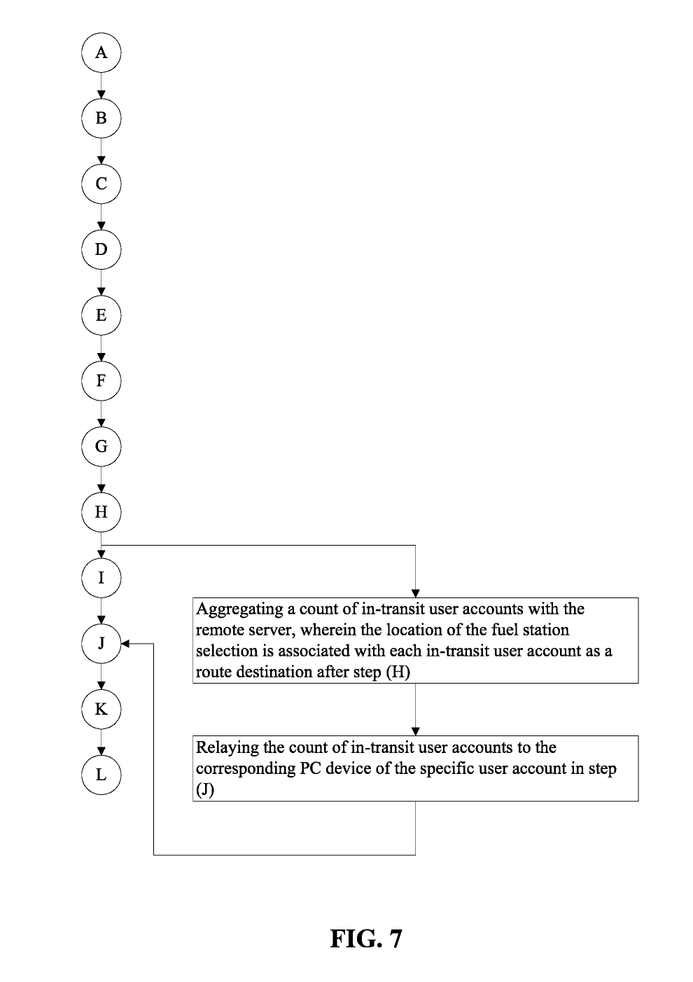

As can be seen in FIG. 7, the method provides a sub-process to identify the total in-transit user accounts with the same fuel station selection as the specific user account. More specifically, the method aggregating a count of in-transit user accounts with the remote server, wherein the location of the fuel station selection is associated with each in-transit user account as a route destination after Step H. Subsequently, the method relays the count of in-transit user accounts to the corresponding PC device of the specific user account in Step J. This process allows the user associated with the specific user account to make a decision whether or not to change the original fuel station selection based on the total vehicles traveling to the same station and thus making the station crowded or even depleting the fuel reserve in the station.

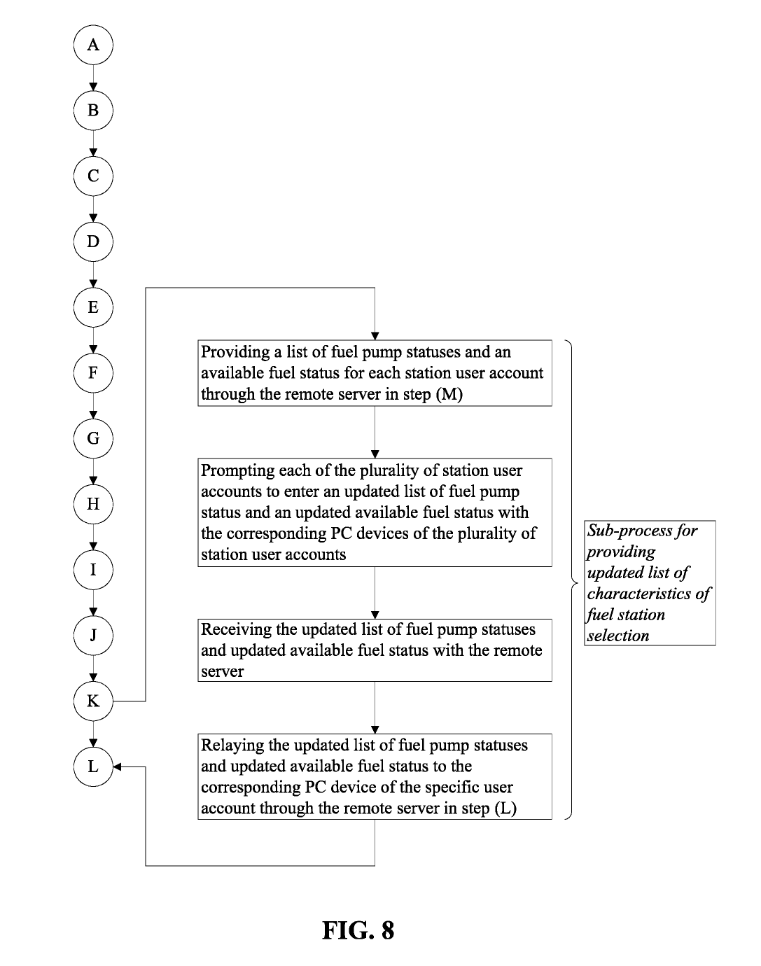

As can be seen in FIG. 8, the method further provides a sub-process that manages the detail fuel and fuel pump statuses associated with the fuel station selection by the specific user account. More specifically, the method provides a list of fuel pump statuses and an available fuel status for each station user account through the remote server in Step K, wherein the statuses may include, but are not limited to, total pumps, available pumps, available fuel for each fuel grade and type, etc. Then, the method prompts each of the plurality of station user accounts to enter an updated list of fuel pump status and an updated available fuel status with the corresponding PC devices of the plurality of station user accounts. When receiving the updated list of fuel pump statuses and updated available fuel status with the remote server, the method relays the updated list of fuel pump statuses and updated available fuel status to the corresponding PC device of the specific user account through the remote server in Step L. This process informs the specific user account with the decision-making process in a critical situation.

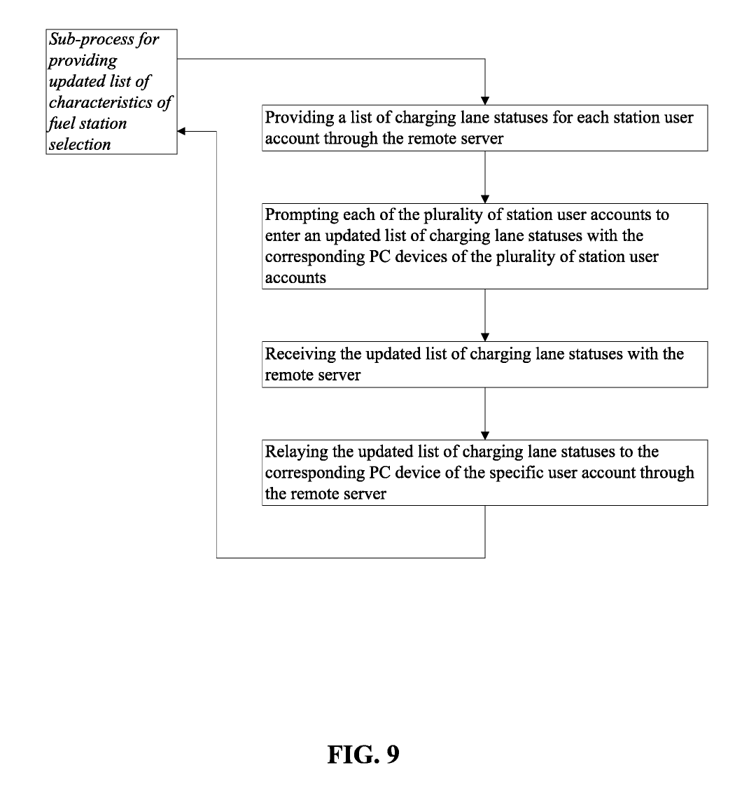

Similarly, in another embodiment, as can be seen in FIG. 9, the method of the present invention provides a list of charging lane statuses for each station user account through the remote server and prompts each of the plurality of station user accounts to enter an updated list of charging lane statuses with the corresponding PC devices of the plurality of station user accounts. Then the method receives the updated list of charging lane statuses with the remote server and relays the updated list of charging lane statuses to the corresponding PC device of the specific user account through the remote server. This process is specifically offered to the EV users. The list of charging lane statuses for each charging station may include, but is not limited to, total charging lanes, available charging lanes, etc.

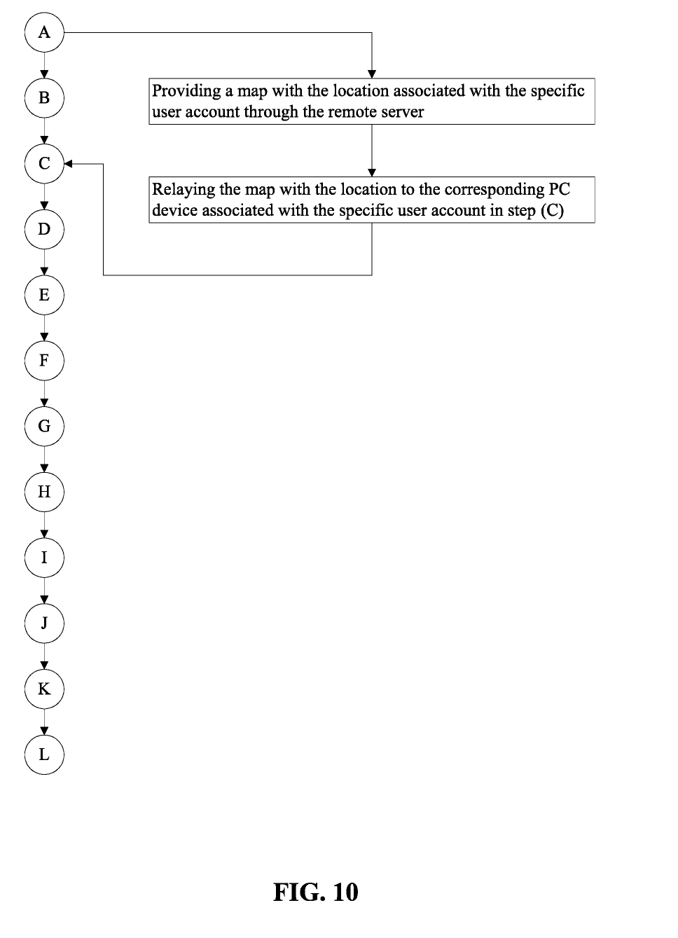

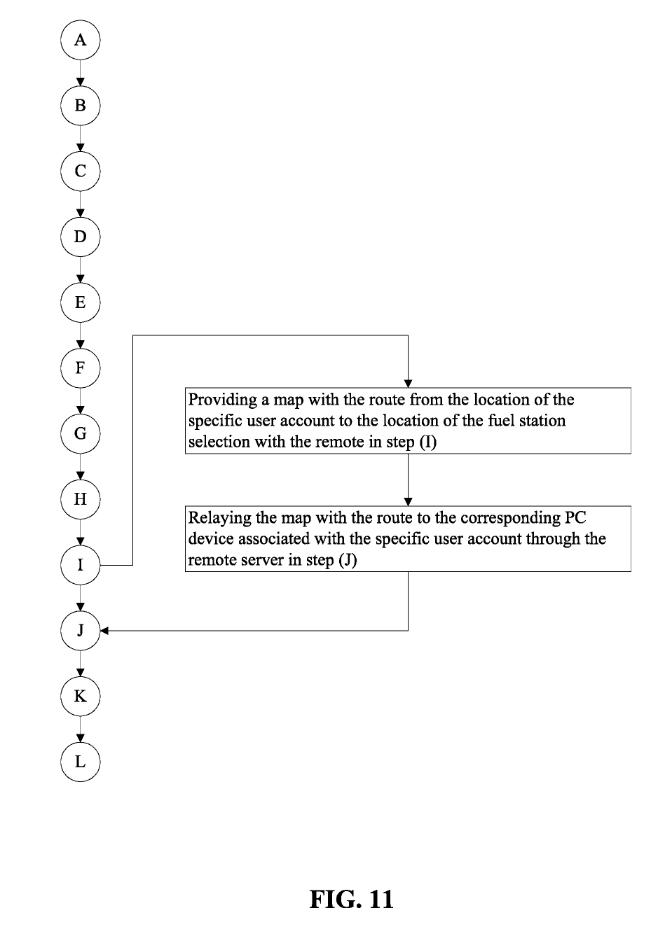

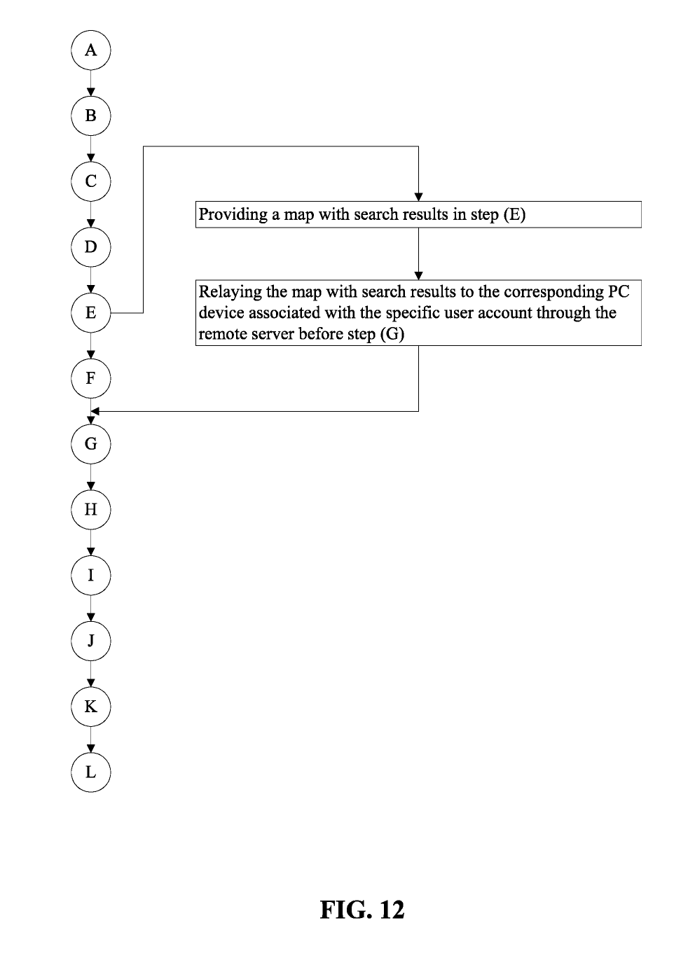

As can be seen in FIG. 10, the method provides a map to present the location of the specific user account. More specifically, the method provides a map with the location associated with the specific user account through the remote server and relays the map with the location to the corresponding PC device associated with the specific user account in Step C. In other embodiments, the method of the present invention may provide any other suitable graphical presentation of the location of the specific user account. Similarly, in another embodiment, as can be seen in FIG. 11, the method provides a map for the route to the specific user. More specifically, the method provides a map with the route from the location of the specific user account to the location of the fuel station selection with the remote in Step I and relaying the map with the route to the corresponding PC device associated with the specific user account through the remote server in Step J. In yet another embodiment, as can be seen in FIG. 12, the method provides a map to present the search results. More specifically, the method provides a map with search results in Step E and relays the map with search results to the corresponding PC device associated with the specific user account through the remote server before Step G. Graphical presentation allows each user to efficiently identify the desired fuel station and make the right decision in an emergency.

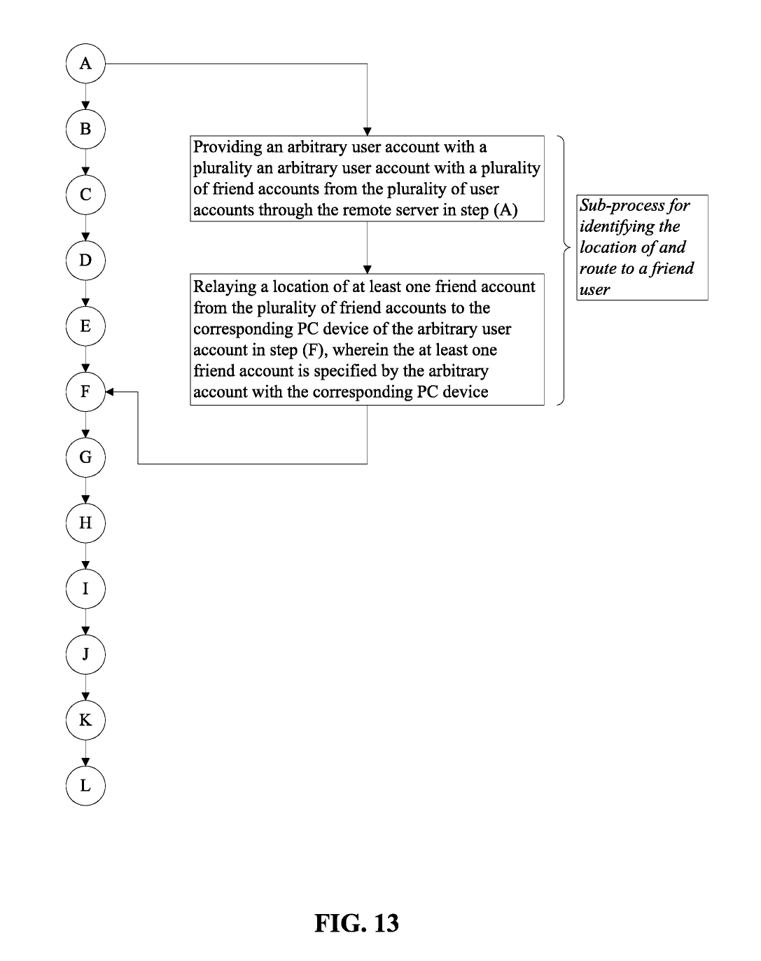

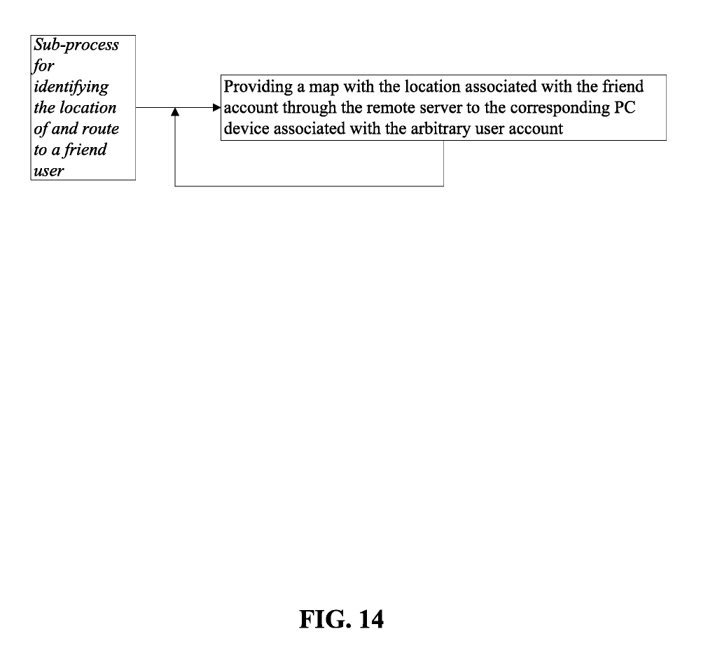

As can be seen in FIG. 13, the method offers a sub-process for locating and tracking a friend. More specifically, the method providing an arbitrary user account with a plurality of friend accounts from the plurality of user accounts through the remote server in Step A. Additionally, the method relays a location of at least one friend account from the plurality of friend accounts to the corresponding PC device of the arbitrary user account in Step F, wherein the at least one friend account is specified by the arbitrary account with the corresponding PC device. In an emergency, the arbitrary user account can locate the friend associated with the friend user account and use the route provided by the present invention to find the friend. For example, the arbitrary user's friend may be lost, hijacked, trapped in a disaster area, etc. In another embodiment, as seen in FIG. 14, the method of the present invention may provide a map of the friend's location. More specifically, the method provides a map with the location associated with the friend account through the remote server to the corresponding PC device associated with the arbitrary user account. Further, the method may provide any other suitable graphical presentation of the friend's location.

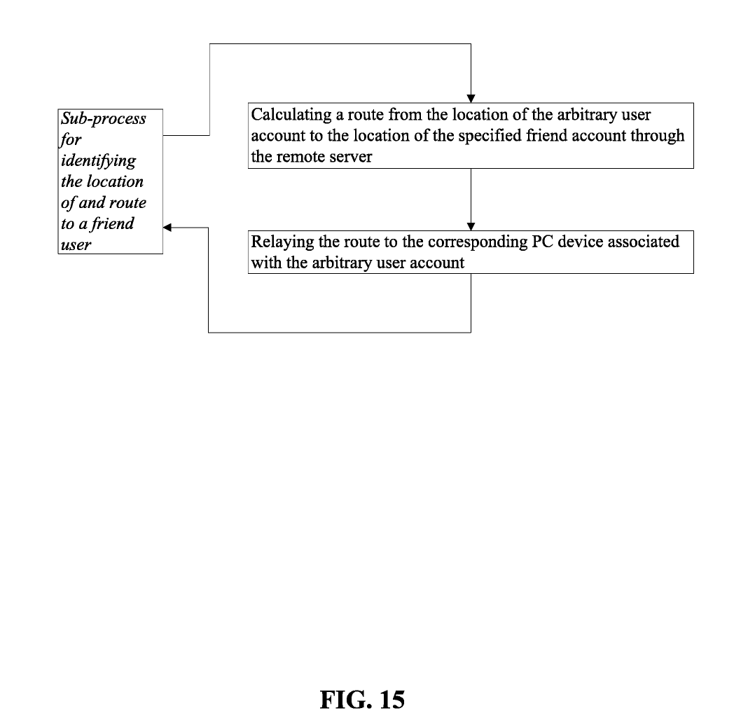

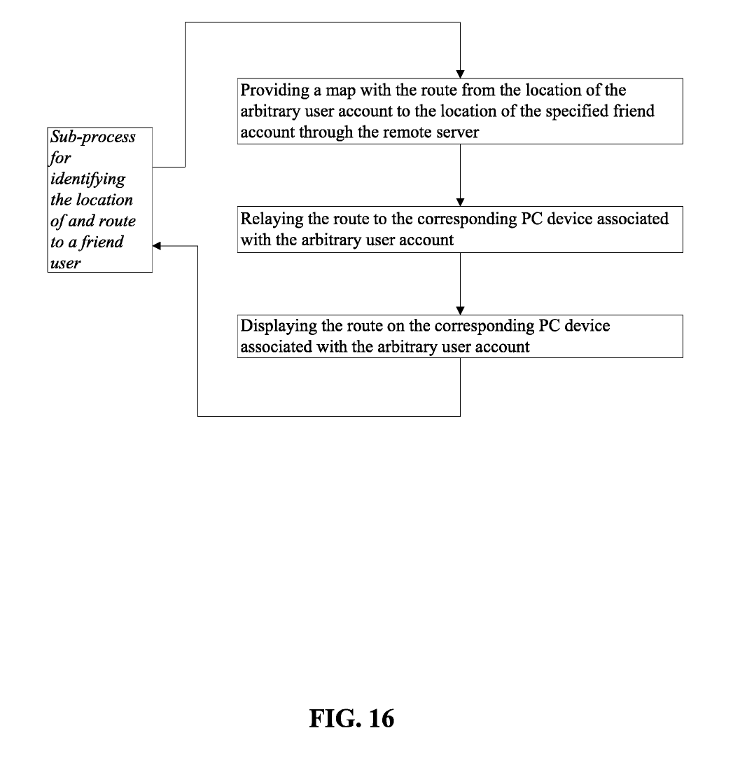

In yet another embodiment of the present invention, as can be seen in FIG. 15, the method offers a sub-process that provides a route for the arbitrary user to physically reach the friend. More specifically, the method calculates a route from the location of the arbitrary user account to the location of the specified friend account through the remote server and relays the route to the corresponding PC device associated with the arbitrary user account. In other embodiments, the method may provide a map with the route from the location of the arbitrary user account to the location of the specified friend account through the remote server, relays the route to the corresponding PC device associated with the arbitrary user account, and displays the route on the corresponding PC device associated with the arbitrary user account, as seen in FIG. 16. The method may use any graphical presentation of the route other than a map to efficiently assist the arbitrary user to reach and/or rescue the friend of the arbitrary user.

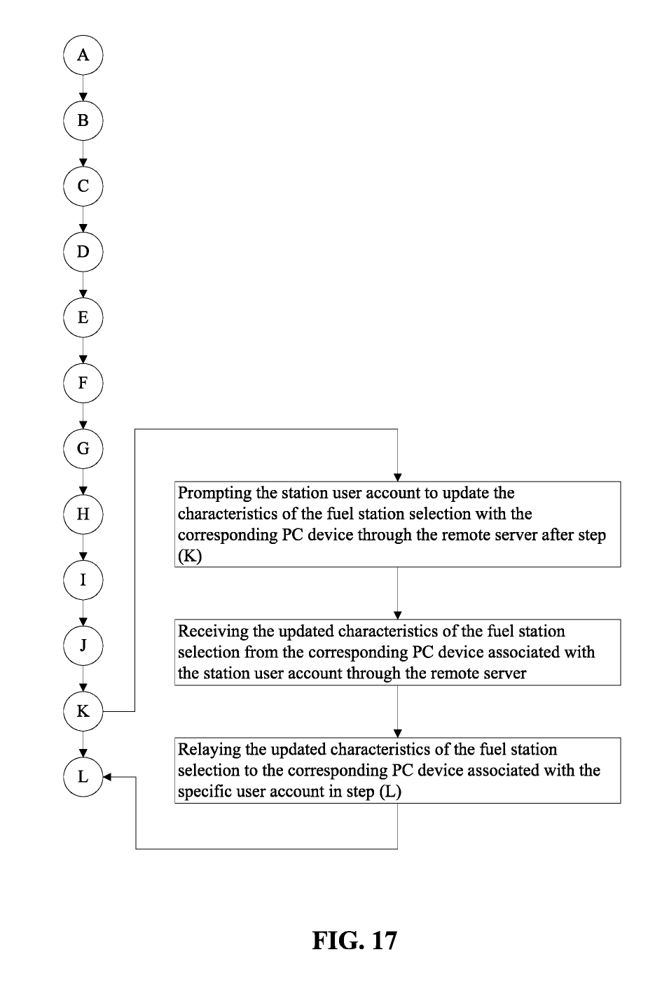

As can be seen in FIG. 17, the method provides a sub-process to manage the characteristics of each fuel station. More specifically, the method prompts each station user account to update the characteristics of the fuel station selection with the corresponding PC device through the remote server after Step K, receives the updated characteristics of the fuel station selection from the corresponding PC device associated with the station user account through the remote server, and relays the updated characteristics of the fuel station selection to the corresponding PC device associated with the specific user account in Step L. This process is critical to the decision-making for the specific user who is in an emergency. On the other hand, this process allows each fuel station user to provide the specific user accurate information regarding the fuel station not only to attract users to improve business performance, but also help save lives in emergency.

Although the invention has been explained in relation to its preferred embodiment, it is to be understood that many other possible modifications and variations can be made without departing from the spirit and scope of the invention as hereinafter claimed.

What is claimed is:

1. A method for providing a self-rescue plan in an emergency, the method comprising the steps of:
(A) providing a plurality of user accounts managed by at least one remote server, wherein the plurality of user accounts comprises a plurality of driver user accounts and a plurality of station user accounts, and wherein each user account is associated with a corresponding personal computing (PC) device;
(B) providing a location associated with each user account from the plurality of driver user accounts through the remote server;
(C) prompting a specific user account from the plurality of user accounts to specify a search radius through the corresponding PC device of the specific user account, wherein a search for a list of available fuel stations is conducted by the remote server;
(D) receiving the specified search radius with the remote server;
(E) conducting the search with the remote server in order to identify a plurality of search results, wherein each of the plurality of search results is associated with one of the plurality of station user accounts, and wherein the location of each of the plurality of search results is within the specified search radius;
(F) relaying the search results to the corresponding PC device of the specific driver user account through the remote server;
(G) displaying the search results on the corresponding PC device of the specific driver user account;
(H) receiving a fuel station selection from the specific user account, wherein the fuel station selection corresponds to one of the search results;
(I) calculating a route from the location of the specific user account to the location of the fuel station selection with the remote server;
(J) relaying the route to the corresponding PC device of the specific user account with the remote server;
(K) providing a set of characteristics for each fuel station through the remote server; and
(L) relaying the fuel station characteristics of the fuel station selection to the corresponding PC device of the specific user account.

2. The method for providing a self-rescue plan in an emergency, the method as claimed in claim 1 comprising the steps of:
prompting the specific user account to specify a search for available charging stations for electric vehicles in step (C);
generating the search results in order to identify a plurality of available charging stations as the search results; and
relaying the search results to the corresponding PC device of the specific user account through the remote server in step (F).

3. The method for providing a self-rescue plan in an emergency, the method as claimed in claim 1 comprising the steps of:
providing a set of supplies and services for each fuel station through the remote server in step (A);
prompting each of the plurality of station user accounts to enter supplies and services for the associated fuel station with the corresponding PC device;
receiving the supplies and services of each of the fuel stations and storing the supplies and services to the remote server; and
relaying the supplies and services of the fuel station selection to the corresponding PC device of the user account in step (H) through the remote server.

4. The method for providing a self-rescue plan in an emergency, the method as claimed in claim 1 comprising the steps of:
identifying a list of secondary services along the route in step (I) with the remote server; and
relaying the list of secondary services to the corresponding PC device of the specific user account in step (J).

5. The method for providing a self-rescue plan in an emergency, the method as claimed in claim 4 comprising the steps of:
providing a map with the list of secondary services displayed along the route; and
relaying the map to the corresponding PC device associated with the specific user account.

6. The method for providing a self-rescue plan in an emergency, the method as claimed in claim 1 comprising the steps of:
aggregating a count of in-transit user accounts with the remote server, wherein the location of the fuel station selection is associated with each in-transit user account as a route destination after step (H); and
relaying the count of in-transit user accounts to the corresponding PC device of the specific user account in step (J);

7. The method for providing a self-rescue plan in an emergency, the method as claimed in claim 1 comprising the steps of:
providing a list of fuel pump statuses and an available fuel status for each station user account through the remote server in step (K);
prompting each of the plurality of station user accounts to enter an updated list of fuel pump status and an updated available fuel status with the corresponding PC devices of the plurality of station user accounts;
receiving the updated list of fuel pump statuses and updated available fuel status with the remote server; and
relaying the updated list of fuel pump statuses and updated available fuel status to the corresponding PC device of the specific user account through the remote server in step (L).

8. The method for providing a self-rescue plan in an emergency, the method as claimed in claim 1 comprising the steps of:
providing a list of charging lane statuses for each station user account through the remote server;
prompting each of the plurality of station user accounts to enter an updated list of charging lane statuses with the corresponding PC devices of the plurality of station user accounts;
receiving the updated list of charging lane statuses with the remote server; and
relaying the updated list of charging lane statuses to the corresponding PC device of the specific user account through the remote server.

9. The method for providing a self-rescue plan in an emergency, the method as claimed in claim 1 comprising the steps of:
providing a map with the location associated with the specific user account through the remote server; and
relaying the map with the location to the corresponding PC device associated with the specific user account in step (C).

10. The method for providing a self-rescue plan in an emergency, the method as claimed in claim 1 comprising the steps of:
providing a map with the route from the location of the specific user account to the location of the fuel station selection with the remote in step (I); and
relaying the map with the route to the corresponding PC device associated with the specific user account through the remote server in step (J).

11. The method for providing a self-rescue plan in an emergency, the method as claimed in claim 1 comprising the steps of:
providing a map with search results in step (E); and
relaying the map with search results to the corresponding PC device associated with the specific user account through the remote server before step (G).

12. The method for providing a self-rescue plan in an emergency, the method as claimed in claim 1 comprising the steps of:
providing an arbitrary user account with a plurality of friend accounts from the plurality of user accounts through the remote server in step (A); and
relaying a location of at least one friend account from the plurality of friend accounts to the corresponding PC device of the arbitrary user account in step (F), wherein the at least one friend account is specified by the arbitrary account with the corresponding PC device.

13. The method for providing a self-rescue plan in an emergency, the method as claimed in claim 12 comprising the steps of:
providing a map with the location associated with the friend account through the remote server to the corresponding PC device associated with the arbitrary user account.

14. The method for providing a self-rescue plan in an emergency, the method as claimed in claim 12 comprising the steps of:
calculating a route from the location of the arbitrary user account to the location of the specified friend account through the remote server; and
relaying the route to the corresponding PC device associated with the arbitrary user account.

15. The method for providing a self-rescue plan in an emergency, the method as claimed in claim 14 comprising the steps of:
providing a map with the route from the location of the arbitrary user account to the location of the specified friend account through the remote server;
relaying the route to the corresponding PC device associated with the arbitrary user account; and
displaying the route on the corresponding PC device associated with the arbitrary user account.

16. The method for providing a self-rescue plan in an emergency, the method as claimed in claim 1 comprising the steps of:
prompting the station user account to update the characteristics of the fuel station selection with the corresponding PC device through the remote server after step (K);
receiving the updated characteristics of the fuel station selection from the corresponding PC device associated with the station user account through the remote server; and
relaying the updated characteristics of the fuel station selection to the corresponding PC device associated with the specific user account in step (L).
